(19) United States
(12) Patent Application Publication
(10) Pub. No.: US 2026/0177868 A1
(43) Pub. Date: Jun. 25, 2026

(54) DISPLAY DEVICE

(71) Applicant: Japan Display Inc., Tokyo (JP)

(72) Inventor: Jin HIROSAWA, Tokyo (JP)

(73) Assignee: Japan Display Inc., Tokyo (JP)

(21) Appl. No.: 19/424,268

(22) Filed: Dec. 18, 2025

(30) Foreign Application Priority Data
Dec. 24, 2024 (JP) 2024-227249

(51) Int. Cl. G02F 1/1362; G09G 3/34

(52) U.S. Cl. CPC G02F 1/136222; G02F 1/136209; G02F 1/136286; G09G 3/3426

(57) ABSTRACT

According to one embodiment, a display device includes a liquid crystal panel including a first area having a first pixel and a second area having a second pixel, and an illumination device. The first pixel includes a color filter. The second pixel does not include a color filter. The illumination device includes a first light source configured to emit white illumination light toward the first area and a second light source comprising a first light emitting element configured to emit illumination light in a first wavelength range toward the second area and a second light emitting element configured to emit illumination light in a second wavelength range toward the second area.

### CROSS-REFERENCE TO RELATED APPLICATION

This application is based upon and claims the benefit of priority from Japanese Patent Application No. 2024-227249, filed Dec. 24, 2024, the entire contents of which are incorporated herein by reference.

### FIELD

Embodiments described herein relate generally to a display device.

### BACKGROUND

Display devices applied, for example, to head-mounted displays demand high definition.

When the size of a pixel is reduced, the ratio of an area of a light-shielding layer defining the pixel with respect to an area of a pixel aperture is increased. This results in decreases in brightness of the pixel. Further, increases in the number of pixels requires more time for writing video signals into more pixels. Thus, time in which image can be displayed is shorten. As a result, brightness of the pixel is decreased. On the other hand, writing video signals into many pixels within a limited time requires a driver with high processing capability, leading to increased cost.

### BRIEF DESCRIPTION OF THE DRAWINGS

FIG. 1 is a perspective view showing an example of an exterior appearance of a head-mounted display 1.

FIG. 2 is a view for describing a configuration of a display device DSP.

FIG. 3 is a view for describing a positional relationship between display devices DSP1 and DSP2 and user's eyes.

FIG. 4 is a plan view for describing a configuration of a liquid crystal panel PNL.

FIG. 5 is a cross-sectional view showing a configuration example of the liquid crystal panel PNL along A-B line of FIG. 4.

FIG. 6 is a view showing a configuration example of an illumination device IL.

FIG. 7 is a diagram for describing an example of controlling of the display device DSP.

FIG. 8 is a view showing another configuration example of the illumination device IL.

FIG. 9 is a view showing another configuration example of the illumination device IL.

FIG. 10 is a view showing a configuration example of a pixel layout in a display area DA.

FIG. 11 is a view showing another configuration example of the pixel layout in the display area DA.

FIG. 12 is a view showing another configuration example of the pixel layout in the display area DA.

FIG. 13 is a view showing another configuration example of the pixel layout in the display area DA.

### DETAILED DESCRIPTION

An object of embodiments is to provide a display device capable of improving display quality.

In general, according to one embodiment, a display device includes a liquid crystal panel including a first area having a plurality of first pixels and a second area having a plurality of second pixels in a display area for displaying images, an illumination device configured to illuminate the liquid crystal panel, and a controller configured to control the liquid crystal panel and the illumination device. Each of the plurality of first pixels includes a color filter. Each of the plurality of second pixels does not include the color filter. The illumination device includes a first light source configured to emit white illumination light toward the first area and a second light source including a first light emitting element configured to emit illumination light in a first wavelength range toward the second area and a second light emitting element configured to emit illumination light in a second wavelength range different from the first wavelength range toward the second area. The controller is configured to control the second area to display a first-color image in the first wavelength range in synchronization with lighting of the first light emitting element, and control the second area to display a second-color image in the second wavelength range in synchronization with lighting of the second light emitting element.

Embodiments will be described hereinafter with reference to the accompanying drawings.

The disclosure is merely an example, and proper changes in keeping with the spirit of the disclosure, which are easily conceivable by a person of ordinary skill in the art, come within the scope of the disclosure as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the disclosure. In addition, in the specification and drawings, structural elements which function in the same or a similar manner to those described in connection with preceding drawings are denoted by like reference numbers, detailed description thereof being omitted unless necessary.

In the figures, an X-axis, a Y-axis, and a Z-axis orthogonal to each other are described to facilitate understanding as needed. A direction parallel to the X-axis is referred to as a first direction X. A direction parallel to the Y-axis is referred to as a second direction Y. A direction parallel to the Z-axis is referred to as a third direction Z. A plan view is defined as appearance when various types of elements are viewed parallel to the third direction Z. When terms indicating the positional relationships of two or more structural elements, such as “on”, “above” “between” and “face”, are used, the target structural elements may be directly in contact with each other or may be spaced apart from each other as a gap or another structural element is interposed between them.

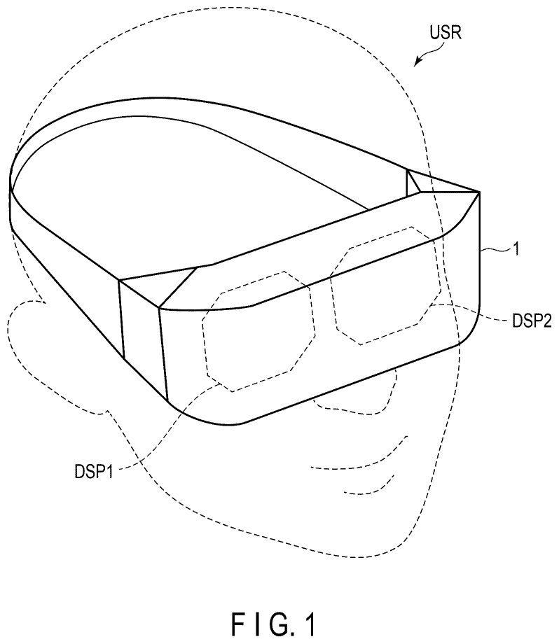

FIG. 1 is a perspective view showing an example of an exterior appearance of a head-mounted display 1.

For example, the head-mounted display 1 is mounted on a head of a user USR. For example, the head-mounted display 1 is used to provide the user USR with virtual reality (VR), augmented reality (AR), or the like.

The head-mounted display 1 comprises a display device DSP1 for a right eye and a display device DSP2 for a left eye. The display device DSP1 is provided to be located in front of the user USR's right eye when the head-mounted display 1 is mounted on the user USR's head. The display device DSP2 is provided to be located in front of the user USR's left eye when the head-mounted display 1 is mounted on the user USR's head.

The display devices DSP1 and DSP2 substantially have the same configuration. The following will describe a display device DSP applicable to each of the display devices DSP1 and DSP2.

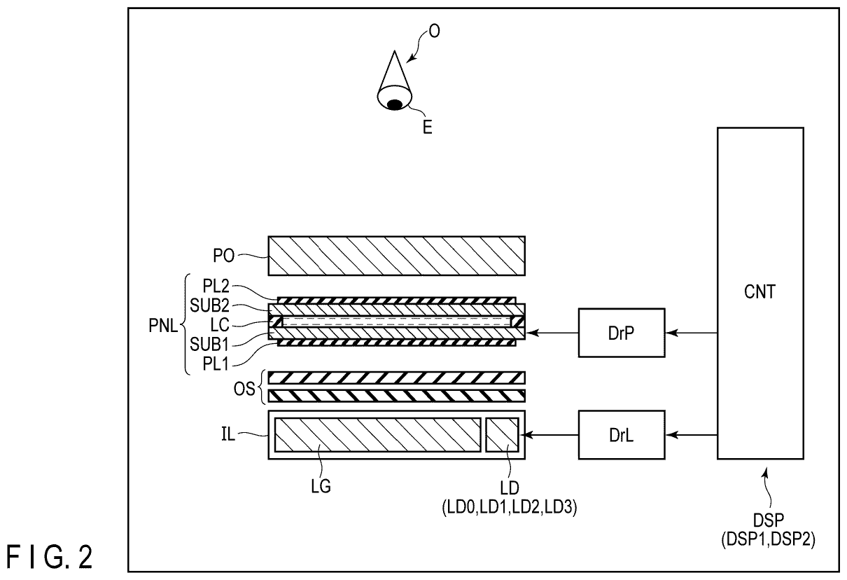

FIG. 2 is a view for describing the configuration of the display device DSP.

The display device DSP comprises an illumination device IL, an optical sheet OS, a liquid crystal panel PNL, a projection optical system PO, and a controller CNT. The controller CNT is configured to control the illumination device IL and the liquid crystal panel PNL.

The illumination device IL is provided behind the liquid crystal panel PNL and is configured to illuminate the liquid crystal panel PNL. For example, the illumination device IL comprises a plurality of light emitting elements LD and a light guide LG. The illumination device IL may not comprise the light guide LG.

The plurality of light emitting elements LD comprise a light emitting element LD0, a light emitting element LD1, a light emitting element LD2, and a light emitting element LD3. The light emitting element LD0 is configured to emit white illumination light. The light emitting element LD1 is configured to emit illumination light in the first wavelength range. The light emitting element LD2 is configured to emit illumination light in the second wavelength range. The light emitting element LD3 is configured to emit illumination light in the third wavelength range.

The first wavelength range, the second wavelength range, and the third wavelength range differ from each other. For example, the second wavelength range is in a longer wavelength range than the first wavelength range, and the third wavelength range is in a longer wavelength range than the second wavelength range. More specifically, the first wavelength range is 400 nm to 500 nm, and the color of the first wavelength range is blue. The second wavelength range is 500 nm to 600 nm, and the color of the second wavelength range is green. The third wavelength range is 600 nm to 700 nm, and the color of the third wavelength range is red.

In one example of the light emitting elements LD, the light emitting element LD1, the light emitting element LD2, and the light emitting element LD3 are light emitting diodes. Furthermore, the light emitting elements LD are not limited to light emitting diodes and may be laser diodes having higher directionality than light emitting diodes. Further, the light emitting elements LD may be combined with a wavelength conversion element to obtain illumination light in the desired wavelength range.

These light emitting elements LD are driven by a light source driver DrL. The light source driver DrL is controlled by the controller CNT.

The liquid crystal panel PNL comprises a first substrate SUB1, a second substrate SUB2, a liquid crystal layer LC, a polarizer PL1, and a polarizer PL2. The liquid crystal layer LC is provided between the first substrate SUB1 and the second substrate SUB2. The polarizer PL1 is attached to the first substrate SUB1. The polarizer PL2 is attached to the second substrate SUB2.

This liquid crystal panel PNL is driven by a panel driver DrP. The panel driver DrP is controlled by the controller CNT.

The plurality of optical sheets OS are provided between the illumination device IL and the liquid crystal panel PNL. For example, the optical sheets OS include a prism sheet and a diffusion sheet.

The projection optical system PO is provided between a user's observation position O and the liquid crystal panel PNL and is configured to project an image displayed on the liquid crystal panel PNL toward a user's eye E. The projection optical system PO is constituted by various optical elements. For example, the projection optical system PO is an optical system referred to as a pancake optical system, which has at least two reflective surfaces and functions to reflect light twice.

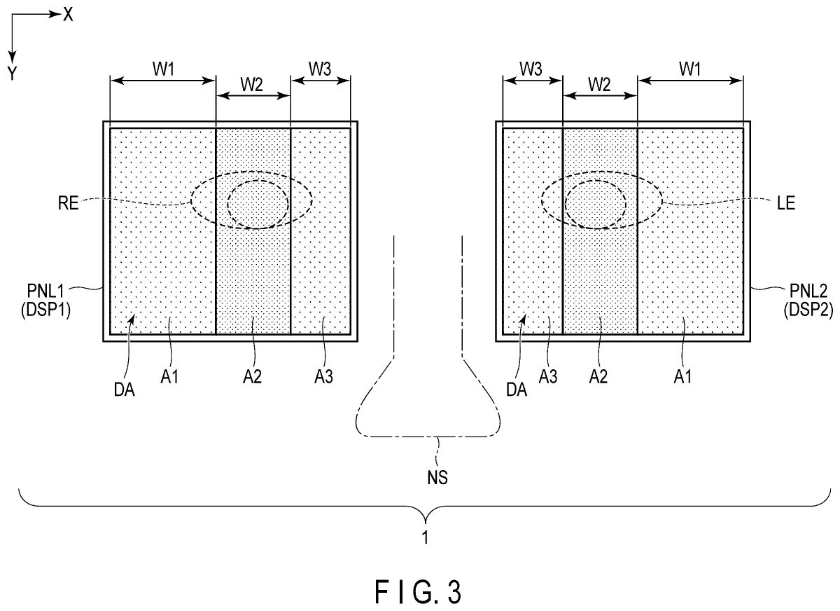

FIG. 3 is a view for describing a positional relationship between the display devices DSP1 and DSP2 and user's eyes.

A liquid crystal panel PNL1 of the display device DSP1 is provided in front of a user's right eye RE. A liquid crystal panel PNL2 of the display device DSP2 is provided in front of a user's left eye LE. In the specification, the direction in which the liquid crystal panel PNL1 and the liquid crystal panel PNL2 are arranged is defined as the first direction X. A direction intersecting the first direction X or orthogonal to the first direction X in a plane parallel to the liquid crystal panels PNL1 and PNL2 is defined as the second direction Y.

In each of the liquid crystal panel PNL1 and the liquid crystal panel PNL2, a display area DA for displaying images comprises a first area A1, a second area A2, and a third area A3. The second area A2 is configured to display high-definition images than the first area A1 and the third area A3. The first area A1 and the third area A3 have the same definition. That is, the first area A1 and the third area A3 correspond to low-definition display areas, and the second area A2 corresponds to a high-definition display area.

In the liquid crystal panel PNL1, the first area A1, the second area A2, and the third area A3 are arranged in this order in the first direction X indicated by the arrow direction. In the liquid crystal panel PNL1, the third area A3 is closer to a user's nose NS or to the liquid crystal panel PNL2 than the first area A1 and the second area A2.

In the liquid crystal panel PNL2, the third area A3, the second area A2, and the first area A1 are arranged in this order in the first direction X indicated by the arrow direction. In the liquid crystal panel PNL2, the third area A3 is closer to the user's nose NS or to the liquid crystal panel PNL1 than the first area A1 and the second area A2.

The first area A1 has a width W1. The second area A2 has a width W2. The third area A3 has a width W3. Here, each of the widths W1, W2, and W3 corresponds to a width along the first direction X. The width W1 differs from the width W3. Here, the width W3 of the third area A3 close to the nose NS is smaller than the width W1 of the first area A1 farther from the nose NS (W1>W3). Thus, the second area A2 is located closer to the nose NS than the central part of the display area DA. In the illustrated example, the second area A2 of the liquid crystal panel PNL1 is located in front of the right eye RE, and the second area A2 of the liquid crystal panel PNL2 is located in front of the left eye LE.

In the human eyeball, cone cells having high resolution and color-discrimination capability but low sensitivity, are densely present in a region called the fovea. In contrast, rod cells having low resolution and no color-discrimination capability but high sensitivity, are densely present outside the fovea.

The fovea lies off the optical axis of the eyeball optical system. In the right eyeball, the fovea lies several degrees to the right of the center. In the left eyeball, the fovea lies several degrees to the left of the center.

When the head-mounted display provides virtual reality or the like, the display device DSP and user's eyeballs are positioned very close to each other. Thus, changing a user's gaze position requires only a small viewpoint shift. Thus, the eyeball optical system and the fovea remain at fixed positions relative to the display device DSP.

Thus, as illustrated, the second area A2 corresponding to the high-definition display area is located closer to the nose NS than the center of the display area DA. This configuration can provide a high-definition image to cone cells in the fovea that exhibit high definition, while providing a low-definition image to rod cells outside the fovea that exhibit low definition.

In the example of FIG. 3, the liquid crystal panels PNL1 and PNL2 each have a rectangular planar shape, but may have planar shapes such as other polygonal shapes or a circular shape. Further, the liquid crystal panels PNL1 and PNL2 may have a notch to avoid contact with the nose NS.

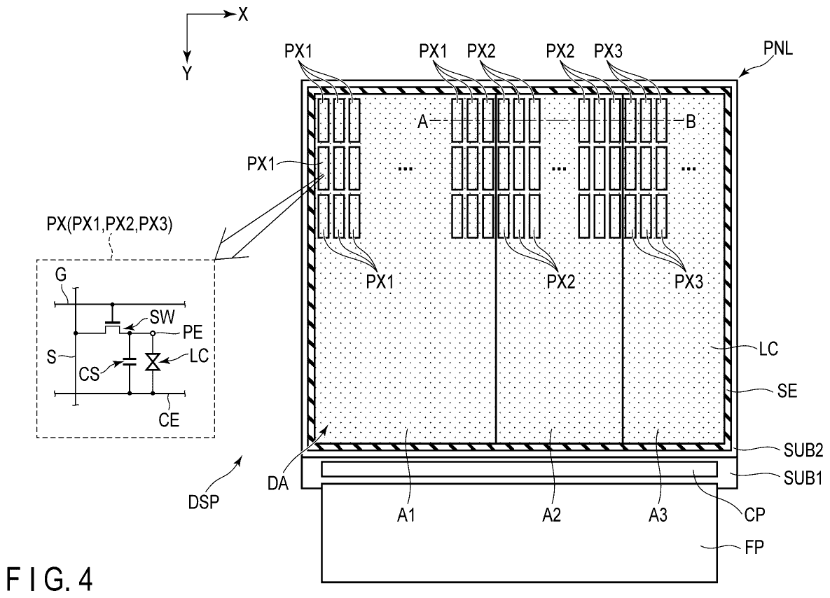

FIG. 4 is a plan view for describing a configuration of the liquid crystal panel PNL. The liquid crystal panel PNL shown here corresponds to the liquid crystal panel PNL1. When the illustrated liquid crystal panel PNL is reversed left to right, this liquid crystal panel PNL corresponds to the liquid crystal panel PNL2.

In plan view, the first substrate SUB1 and the second substrate SUB2 overlap each other and are bonded to each other by a seal SE. The liquid crystal layer LC is sealed by the seal SE between the first substrate SUB1 and the second substrate SUB2.

The liquid crystal panel PNL has the display area DA for displaying images in the area where the liquid crystal layer LC is sealed. The display area DA comprises a plurality of pixels PX arranged in a matrix in the first direction X and the second direction Y. Specifically, the first area A1 includes a plurality of pixels PX1 arranged in a matrix. The second area A2 includes a plurality of pixels PX2 arranged in a matrix. The third area A3 includes a plurality of pixels PX3 arranged in a matrix. In the display area DA, the plurality of pixels PX1, the plurality of pixels PX2, and the plurality of pixels PX3 are arranged in this order in the first direction X.

As enlarged in the figure, each of the pixel PX1, the pixel PX2, and the pixel PX3 comprises a switching element SW, a pixel electrode PE, and a common electrode CE. The switching element SW is constituted, for example, by a thin-film transistor (TFT) and is electrically connected to a scanning line G and a signal line S.

The scanning line G extends in the first direction X across the first area A1, the second area A2, and the third area A3 and is electrically connected to the switching element SW in each of the plurality of pixels PX arranged in the first direction X. The signal line S extends in the second direction Y, intersects the scanning line G, and is electrically connected to the switching element SW in each of the pixels PX arranged in the second direction Y.

The pixel electrode PE is electrically connected to the switching element SW. Each of the pixel electrodes PE faces the common electrode CE and drives the liquid crystal layer LC using an electric field generated between the pixel electrode PE and the common electrode CE. A capacitor CS is formed, for example, between an electrode having the same potential as the common electrode CE and an electrode having the same potential as the pixel electrode PE.

In the illustrated example, an IC chip CP and a flexible printed circuit board FP for driving the liquid crystal panel PNL are mounted on the first substrate SUB1. The IC chip CP may be mounted on the flexible printed circuit board FP. The panel driver DrP shown in in FIG. 2 includes a signal-line driver that applies a voltage according to a video signal to each of the signal lines S and a scanning-line driver that applies a voltage according to a control signal to each of the scanning lines G. For example, this panel driver DrP is incorporated in the IC chip CP.

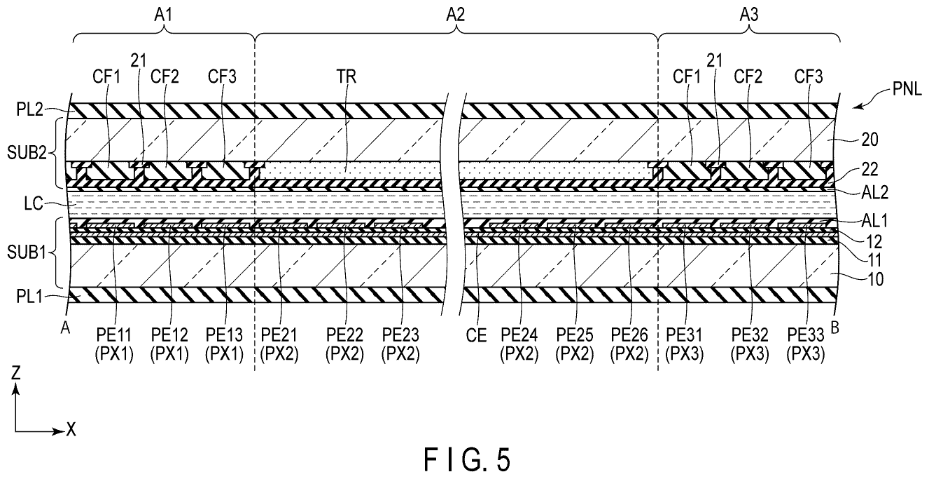

FIG. 5 is a cross-sectional view showing a configuration example of the liquid crystal panel PNL along A-B line of FIG. 4.

The first substrate SUB1 comprises a transparent substrate 10, a circuit layer 11, the common electrode CE, an insulating layer 12, a plurality of pixel electrodes, and an alignment film AL1.

The circuit layer 11 comprises the scanning lines, the signal lines, the switching elements, various insulating films, and the like. The common electrode CE is provided between the circuit layer 11 and the insulating layer 12 and extends across the first area A1, the second area A2, and the third area A3.

As a plurality of pixel electrodes, pixel electrodes PE11 to PE13 provided in each pixel PX1, pixel electrodes PE21 to PE26 provided in each pixel PX2, and pixel electrodes PE31 to PE33 provided in each pixel PX3 are provided on the insulating layer 12 and covered with the alignment layer AL1. In the third direction Z, the common electrode CE overlaps the pixel electrodes PE11 to PE13, the pixel electrodes PE21 to PE26, and the pixel electrodes PE31 to PE33 via the insulating layer 12.

The plurality of pixel electrodes and the common electrode CE are transparent electrodes formed of a conductive oxide such as an indium tin oxide (ITO). The insulating layer 12 is an interlayer insulating film formed of an inorganic insulating material such as a silicon nitride. The alignment film AL1 is in contact with the liquid crystal layer LC.

The second substrate SUB2 comprises a transparent substrate 20, a black matrix 21, color filters CF1 to CF3, a transparent resin layer TR, an overcoat layer 22, and an alignment film AL2.

The black matrix 21 is provided between adjacent pixels PX1 in the first area A1 and between adjacent pixels PX3 in the third area A3. In contrast, the black matrix 21 is not provided between adjacent pixels PX2 in the second area A2.

The color filters CF1 to CF3 are colored in different colors. For example, the color filter CF1 is colored in a color of the first wavelength range (for example, blue), the color filter CF2 is colored in a color of the second wavelength range (for example, green), and the color filter CF3 is colored in a color of the third wavelength range (for example, red).

The pixels PX1 in the first area A1 comprise the color filters CF1 to CF3. The pixels PX3 in the third area A3 comprise the color filters CF1 to CF3. In contrast, the pixels PX2 in the second area A2 comprise none of the color filters CF1 to CF3.

For example, in the first area A1, the color filter CF1 overlaps the pixel electrode PE11 in the third direction Z. Similarly, the color filter CF2 overlaps the pixel electrode PE12, and the color filter CF3 overlaps the pixel electrode PE13.

In the third area A3, the color filter CF1 overlaps the pixel electrode PE31 in the third direction Z. Similarly, the color filter CF2 overlaps the pixel electrode PE32, and the color filter CF3 overlaps the pixel electrode PE33.

Instead of the color filters CF1 to CF3, the transparent resin layer TR is provided in the second area A2. That is, the pixel PX2 of the second area A2 comprises the transparent resin layer TR. In the illustrated example, the transparent resin layer TR and the color filters CF1 to CF3 are in contact with the transparent substrate 20. In the second area A2, the transparent resin layer TR overlaps the pixel electrodes PE21 to PE26 in the third direction Z. In contrast, the transparent resin layer TR is not provided in the first area A1 and the third area A3.

The overcoat layer 22 covers the color filters CF1 to CF3 and the transparent resin layer TR. The overcoat layer 22 is formed of a transparent resin material and functions as a planarization layer that planarizes a surface facing the liquid crystal layer LC across the first area A1, the second area A2, and the third area A3.

The alignment film AL2 covers the overcoat layer 22. The alignment film AL2 is in contact with the liquid crystal layer LC.

The color filters CF1 to CF3 are not limited to the illustrated examples but may alternatively be provided on the first substrate SUB1. The common electrode CE is not limited to the illustrated example but may alternatively be provided on the second substrate SUB2.

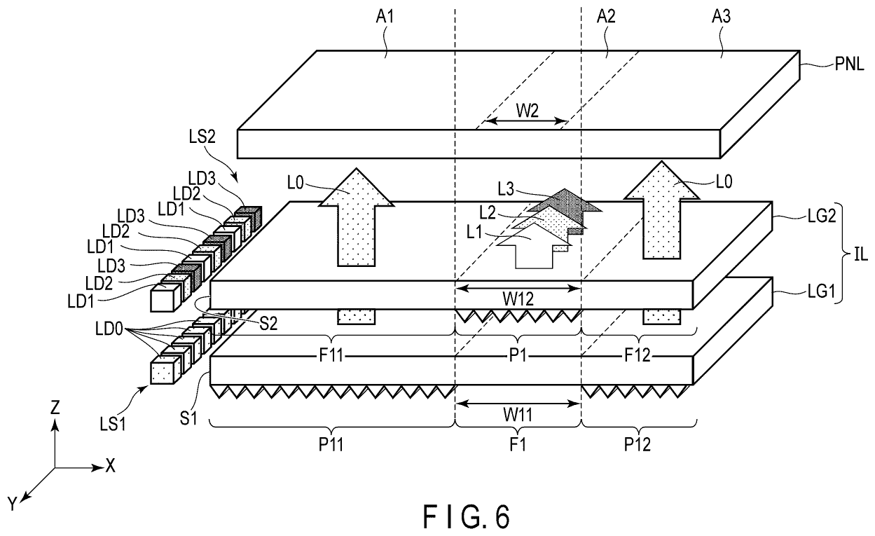

FIG. 6 is a view showing a configuration example of the illumination device IL.

The illumination device IL comprises a light guide LG1, a light guide LG2, a light source LS1 and a light source LS2.

Each of the light guide LG1 and the light guide LG2 has a flat plate shape having a main surface (the upper surface) along the X-Y plane defined by the first direction X and the second direction Y. The light guide LG2 overlaps the light guide LG1 in the third direction Z. The light guide LG2 is located between the liquid crystal panel PNL and the light guide LG1. Each of the light guide LG1 and the light guide LG2 overlaps the first area A1, the second area A2, and the third area A3 of the liquid crystal panel PNL in the third direction Z. The optical sheet OS show in FIG. 2 is interposed between the light guide LG2 and the liquid crystal panel PNL. Here, the illustration of the optical sheet OS is omitted.

The light guide LG1 has a side surface S1. The side surface S1 is, for example, a surface parallel to the Y-Z plane defined by the second direction Y and the third direction Z. The light guide LG2 has a side surface S2. For example, the side surface S2 is a surface parallel to the Y-Z plane. When the light guide LG1 and the light guide LG2 have the same dimensions, the side surface S2 is located directly above the side surface S1 in the third direction Z.

The light source LS1 faces the side surface S1 in the first direction X. The light source LS1 comprises a plurality of light emitting elements LD0. The plurality of light emitting elements LD0 are arranged in the second direction Y. As described above, the light emitting elements LD0 are configured to emit white illumination light.

The light source LS2 faces the side surface S2 in the first direction X and overlaps the light source LS1 in the third direction Z. The light source LS2 comprises a plurality of light emitting elements LD1, a plurality of light emitting elements LD2, and a plurality of light emitting elements LD3. One light emitting element LD1, one light emitting element LD2, and one light emitting element LD3 are arranged in the second direction Y. As described above, the light emitting element LD1 is configured to emit illumination light in the first wavelength range, the light emitting element LD2 is configured to emit illumination light in the second wavelength range, and the light emitting element LD3 is configured to emit illumination light in the third wavelength range.

The light guide LG1 includes a prism portion P11, a prism portion P12 and a flat portion F1 located between the prism portion P11 and the prism portion P12. In the third direction Z, the prism portion P11 overlaps the first area A1, the flat portion F1 overlaps the second area A2, and the prism portion P12 overlaps the third area A3. Each of the prism portion P11 and the prism portion P12 is an area where a plurality of prisms are arranged and has a function of reflecting illumination light propagating through the light guide LG1 toward the liquid crystal panel PNL. The flat portion F1 is an area having a plane parallel to the X-Y plane.

The light guide LG2 includes a flat portion F11, a flat portion F12 and a prism portion P2 located between the flat portion F11 and the flat portion F12. In the third direction Z, the flat portion F11 overlaps the first area A1 and the prism portion P11, the prism portion P2 overlaps the second area A2 and the flat portion F1, and the flat portion F12 overlaps the third area A3 and the prism portion P12. The prism portion P2 is an area where a plurality of prisms are arranged and has a function of reflecting illumination light propagating through the light guide LG2 toward the liquid crystal panel PNL. Each of the flat portion F11 and the flat portion F12 is an area having planes parallel to the X-Y plane.

When the light emitting elements LD0 of the light source LS1 lights in the illumination device IL, illumination light L0 emitted from the light emitting element LD0 toward the side surface S1 propagates through the light guide LG1 and is reflected at the prism portion P11 and the prism portion P12. The illumination light L0 reflected at the prism portion P11 passes through the flat portion F11 and illuminates the first area A1. The illumination light L0 reflected at the prism portion P12 passes through the flat portion F12 and illuminates the third area A3.

That is, the light source LS1 is configured to emit the illumination light L0 toward the first area A1 and the third area A3 using the function of the light guide LG1.

When the light emitting element LD1 of the light source LS2 lights in the illumination device IL, illumination light L1 in the first wavelength range (for example, blue) emitted from the light emitting element LD1 toward the side surface S2 propagates through the light guide LG2 and is reflected at the prism portion P2. The illumination light L1 reflected at the prism portion P2 illuminates the second area A2.

Similarly, when the light emitting element LD2 lights, illumination light L2 in the second wavelength range (for example, green) emitted from the light emitting element LD2 toward the side surface S2 propagates through the light guide LG2 and is reflected at the prism portion P2. The illumination light L2 reflected at the prism portion P2 illuminates the second area A2.

Similarly, when the light emitting element LD3 lights, illumination light L3 in the third wavelength range (for example, red) emitted from the light emitting element LD3 toward the side surface S2 propagates through the light guide LG2 and is reflected at the prism portion P2. The illumination light L3 reflected at the prism portion P2 illuminates the second area A2.

That is, the light source LS2 is configured to emit the illumination light L1, the illumination light L2, and the illumination light L3 toward the second area A2 using the function of the light guide LG2.

For reliable illumination of the second area A2 with the illumination light L1, the illumination light L2, and the illumination light L3, a width W12 of the prism portion P2 along the first direction X is preferably greater than the width W2 of the second area A2 along the first direction X. To prevent illumination light emitted from the light source LS1 from reaching the second area A2, a width W11 of the flat portion F1 along the first direction X is preferably greater than the width W2.

In the first area A1 having the above configuration, color images can be displayed by selectively transmitting the white illumination light L0 in each of the pixels PX1 including the color filters CF1 to CF3. In the third area A3, color images can be displayed by selectively transmitting the white illumination light L0 in each of the pixels PX3 including the color filters CF1 to CF3.

The second area A2 adopts the field sequential color system. That is, the second area A2 can display color images by selectively transmitting the illumination light L1 in the first wavelength range, the illumination light L2 in the second wavelength range, and the illumination light L3 in the third wavelength range in sequence in each pixel PX2 comprising no color filter.

In the configuration of FIG. 6, the set of the light source LS2 and the light guide LG2 is provided between the light guide LG1 and the liquid crystal panel PNL. Alternatively, the set of the light source LS1 and the light guide LG1 may be provided between the light guide LG2 and the liquid crystal panel PNL.

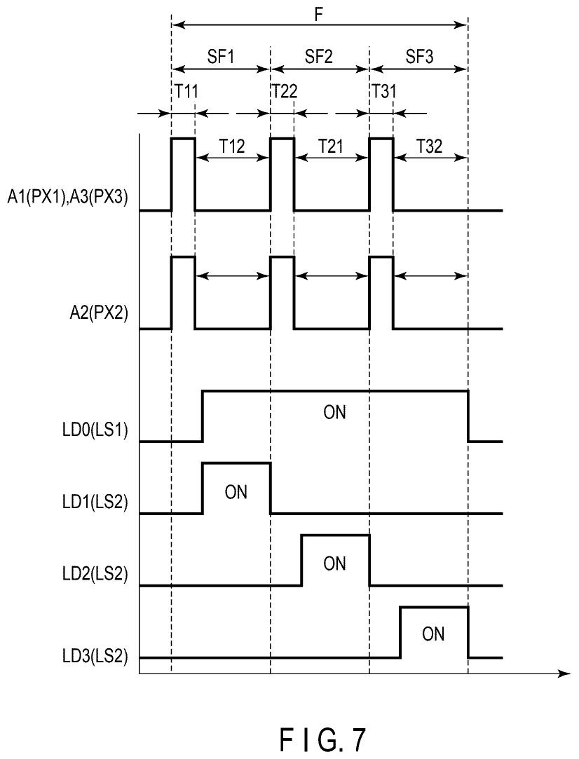

FIG. 7 is a view for describing an example of controlling of the display device DSP.

The horizontal axis in the figure represents time. A one-frame period F for displaying a color image in the display area DA of the liquid crystal panel PNL has a sub-frame period SF1, a sub-frame period SF2, and a sub-frame period SF3.

In the second area A2, the sub-frame period SF1 corresponds to a period for displaying a color image in the first wavelength range, the sub-frame period SF2 corresponds to a period for displaying a color image in the second wavelength range, and the sub-frame period SF3 corresponds to a period for displaying a color image in the third wavelength range.

In the first area A1 and the third area A3, each of the sub-frame period SF1, the sub-frame period SF2, and the sub-frame period SF3 corresponds to a period for displaying the same color image.

The controller CNT shown in FIG. 2 performs the write control of video signals into pixels and the drive control of the light emitting elements described below.

The sub-frame period SF1 includes a period T11 for writing video signals into pixels PX and a period T12 for holding the video signals written into the pixels PX.

During the period T11, a video signal corresponding to a color image in the first wavelength range is written into the pixel PX1 that displays a color in the first wavelength range (or the pixel comprising the color filter CF1) among the pixels PX1 in the first area A1. A video signal corresponding to a color image in the second wavelength range is written into the pixel PX1 that displays a color in the second wavelength range (or the pixel comprising the color filter CF2) among the pixels PX1. A video signal corresponding to a color image in the third wavelength range is written into the pixel PX1 that displays a color in the third wavelength range (or the pixel comprising the color filter CF3) among the pixels PX1.

During the period T11, a video signal corresponding to a color image in the first wavelength range is written into the pixel PX3 that displays a color in the first wavelength range (or the pixel comprising the color filter CF1) among the pixels PX3 in the third area A3. A video signal corresponding to a color image in the second wavelength range is written into the pixel PX3 that displays a color in the second wavelength range (or the pixel comprising the color filter CF2) among the pixels PX3. A video signal corresponding to a color image in the third wavelength range is written into the pixel PX3 that displays a color in the third wavelength range (or the pixel comprising the color filter CF3) among the pixels PX3.

During the period T11, video signals (the first sub-video signals) corresponding to a color image in the first wavelength range are written into all of the pixels PX2 in the second area A2.

The plurality of light emitting elements LD0 in the light source LS1 light at a predetermined duty ratio to illuminate the first area A1 and the third area A3 during the period T12. Further, the plurality of light emitting elements LD1 in the light source LS2 light at a predetermined duty ratio to illuminate the second area A2 during the period T12.

The sub-frame period SF2 includes a period T21 for writing video signals into pixels PX and a period T22 for holding the video signals written into the pixels PX.

During the period T21, the same video signals as those written during the period T11 are written in each of the pixels PX1 in the first area A1.

During the period T21, the same video signals as those written during the period T11 are written in each of the pixels PX3 in the first area A3.

During the period T21, video signals (the second sub-video signals) corresponding to a color image in the second wavelength range are written into all of the pixels PX2 in the second area A2. The second sub-video signals written during the period T21 may differ from the first sub-video signals written during the period T11.

The plurality of light emitting elements LD0 light at a prescribed duty ratio during the period T22 and illuminate the first area A1 and the third area A3. The plurality of light emitting elements LD2 light at a prescribed duty ratio during the period T22 and illuminate the second area A2.

The sub-frame period SF3 includes a period T31 for writing video signals into pixels PX and a period T32 for holding the video signals written into the pixels PX.

During the period T31, the same video signals as those written during the period T11 are written in each of the pixels PX1 in the first area A1. That is, the same video signals are written three times into the pixel PX1 in the one-frame period F.

During the period T31, the same video signals as those written during the period T11 are written in each of the pixels PX3 in the first area A3. Thus, the same video signals are written three times into the pixel PX3 in the one-frame period F.

During the period T31, video signals (the third sub-video signals) corresponding to color a image in the third wavelength range are written into all of the pixels PX2 in the second area A2. The third sub-video signals written during the period T31 may differ from at least one of the first sub-video signals and the second sub-video signals.

The plurality of light emitting elements LD0 light at a prescribed duty ratio during the period T32 and illuminate the first area A1 and the third area A3. The plurality of light emitting elements LD3 light at a prescribed duty ratio during the period T32 and illuminate the second area A2.

The controller CNT shown in FIG. 2 controls the light source driver DrL and the panel driver DrP. The following will describe a control example for displaying a color image in the second area A2.

First, during the sub-frame period SF1, the controller CNT controls such that, in synchronization with lighting of the plurality of light emitting elements LD1, the second area A2 displays a color image in the first wavelength range. At this time, both of the plurality of light emitting elements LD2 and the plurality of light emitting elements LD3 do not light. In contrast, the plurality of light emitting elements LD0 light simultaneously with the light emitting elements LD1.

Next, during the sub-frame period SF2, the controller CNT controls such that, in synchronization with lighting of the plurality of light emitting elements LD2, the second area A2 displays a color image in the second wavelength range. At this time, both of the plurality of light emitting elements LD1 and the plurality of light emitting elements LD3 do not light. In contrast, the plurality of light emitting elements LD0 light simultaneously with the light emitting elements LD2.

Next, during the sub-frame period SF3, the controller CNT controls such that, in synchronization with lighting of the plurality of light emitting elements LD3, the second area A2 displays a color image in the third wavelength range. At this time, both of the plurality of light emitting elements LD1 and the plurality of light emitting elements LD2 do not light. In contrast, the plurality of light emitting elements LD0 light simultaneously with the light emitting elements LD3.

Thus, the second area A2 can display the color image.

The first area A1 and the third area A3 are illuminated by the light emitting elements LD0 lighting across the sub-frame period SF1, the sub-frame period SF2, and the sub-frame period SF3 and thus can the display color image.

As described above, each of the first area A1 and the third area A3 displays the color image with three pixels comprising the color filters CF1 to CF3. In contrast, the second area A2 can display the color image with one pixel by applying a field-sequential color system. Consequently, when the pixel PX2 has the same size as the pixels PX1 and PX3, the second area A2 achieves higher definition than the first area A1 and the third area A3. In addition, the second area A2 does not comprise a color filter and does not comprise a black matrix. Thus, the pixel PX2 suffers no light absorption by a color filter. Further, omission of the black matrix in the pixel PX2 can increase an effective display area. Thus, luminance per pixel PX2 increases. This configuration can improve display quality.

Next, the following will describe other configuration examples of the illumination device IL. In each of the following embodiments, the same constituent elements as in the above configuration example are denoted by the same reference numerals and their overlapping explanations may be omitted in some cases.

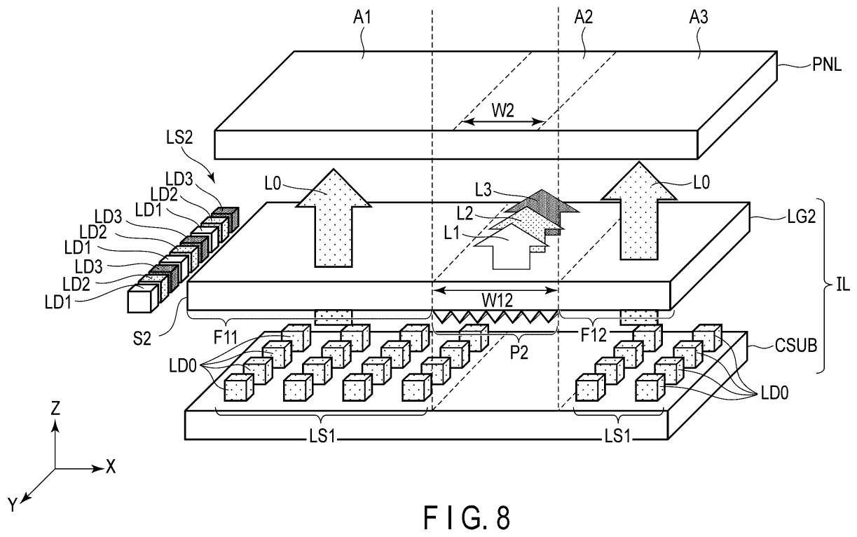

FIG. 8 is a view showing another configuration example of the illumination device IL.

The illumination device IL comprises the light guide LG2, the light source LS1, the light source LS2, and a circuit substrate CSUB.

The light guide LG2 has a plate shape having a main surface (an upper surface) along the X-Y plane. The light guide LG2 is located between the liquid crystal panel PNL and the circuit substrate CSUB. The light guide LG2 overlaps the first area A1, the second area A2, and the third area A3 of the liquid crystal panel PNL in the third direction Z.

The light source LS1 is provided directly below the first area A1 and the third area A3 in the third direction Z. The plurality of light emitting elements LD0 of the light source LS1 are mounted on the circuit substrate CSUB and arranged in a matrix in the first direction X and the second direction Y. As described above, the light emitting elements LD0 are configured to emit white illumination light.

The light source LS2 faces the side surface S2 of the light guide LG2 in the first direction X. One light emitting element LD1, one light emitting element LD2, and one light emitting element LD3 in the light source LS2 are arranged in the second direction Y. As described above, the light emitting element LD1 is configured to emit illumination light in the first wavelength range, the light emitting element LD2 is configured to emit illumination light in the second wavelength range, and the light emitting element LD3 is configured to emit illumination light in the third wavelength range.

The light guide LG2 includes a flat portion F11, a flat portion F12 and a prism portion P2 located between the flat portion F11 and the flat portion F12. In the third direction Z, the flat portion F11 overlaps the first area A1 and the light source LS1, the prism portion P2 overlaps the second area A2, and the flat portion F12 overlaps the third area A3 and the light source LS1. The prism portion P2 is an area where a plurality of prisms are arranged and has a function of reflecting illumination light propagating through the light guide LG2 toward the liquid crystal panel PNL.

When the light emitting element LD0 of the light source LS1 lights in this illumination device IL, the illumination light L0 emitted from the light emitting element LD0 passes through the flat portion F11 and illuminates the first area A1. Further, the illumination light L0 passes through the flat portion F12 and illuminates the third area A3. That is, the light source LS1 is configured to emit the illumination light L0 toward the first area A1 and the third area A3.

When the light emitting element LD1 of the light source LS2 lights in the illumination device IL, the illumination light L1 in the first wavelength range (for example, blue) emitted from the light emitting element LD1 is reflected at the prism portion P2 and illuminates the second area A2.

Similarly, when the light emitting element LD2 lights, the illumination light L2 in the second wavelength range (for example, green) emitted from the light emitting element LD2 is reflected at the prism portion P2 and illuminates the second area A2.

Similarly, when the light emitting element LD3 lights, the illumination light L3 in the third wavelength range (for example, red) emitted from the light emitting element LD3 is reflected at the prism portion P2 and illuminates the second area A2. That is, the light source LS2 is configured to emit the illumination light L1, the illumination light L2, and the illumination light L3 toward the second area A2 using the function of the light guide LG2.

For reliable illumination of the second area A2 with the illumination light L1, the illumination light L2, and the illumination light L3, the width W12 of the prism portion P2 along the first direction X is preferably greater than the width W2 of the second area A2 along the first direction X.

The display device adopting this illumination device IL can achieve the same effects as in the configuration example. Compared with the configuration example shown in FIG. 6, the light guide LG1 is omitted. Thus, the number of components is reduced and cost is lowered.

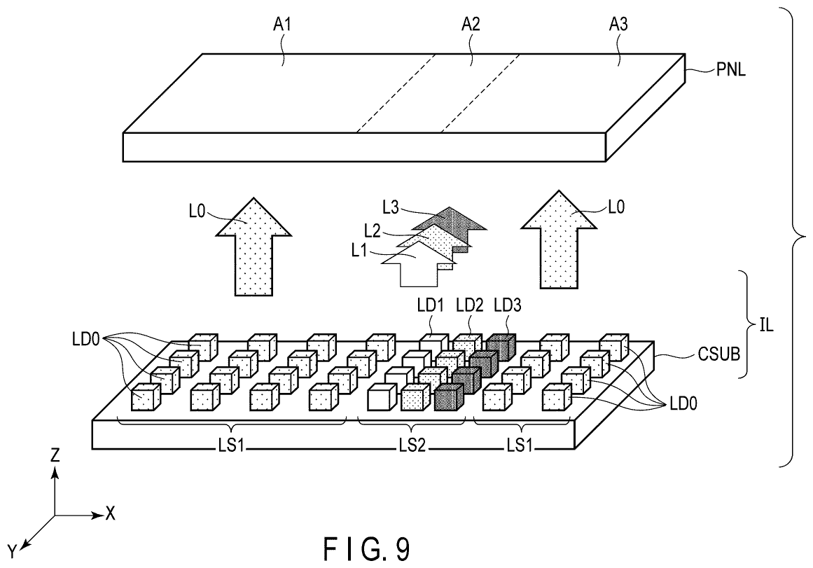

FIG. 9 is a view showing another configuration example of the illumination device IL.

The illumination device IL comprises the light source LS1, the light source LS2 and the circuit substrate CSUB.

The light source LS1 is provided directly below the first area A1 and the third area A3 in the third direction Z. The plurality of light emitting elements LD0 of the light source LS1 are mounted on the circuit substrate CSUB and arranged in a matrix in the first direction X and the second direction Y. As described above, the light emitting elements LD0 are configured to emit white illumination light.

The light source LS2 is provided directly below the second area A2 in the third direction Z. The plurality of light emitting elements LD1, the plurality of light emitting elements LD2, and the plurality of light emitting elements LD3 of the light source LS2 are mounted on the circuit substrate CSUB and arranged in a matrix in the first direction X and the second direction Y. As described above, the light emitting element LD1 is configured to emit illumination light in the first wavelength range, the light emitting element LD2 is configured to emit illumination light in the second wavelength range, and the light emitting element LD3 is configured to emit illumination light in the third wavelength range.

When the light emitting elements LD0 of the light source LS1 lights in this illumination device IL, the illumination light L0 emitted from the light emitting element LD0 illuminates the first area A1 and the third area A3. That is, the light source LS1 is configured to emit the illumination light L0 toward the first area A1 and the third area A3.

When the light emitting element LD1 of the light source LS2 lights in the illumination device IL, the illumination light L1 in the first wavelength range (for example, blue) emitted from the light emitting element LD1 illuminates the second area A2. Similarly, when the light emitting element LD2 lights, the illumination light L2 in the second wavelength range (for example, green) emitted from the light emitting element LD2 illuminates the second area A2. Similarly, when the light emitting element LD3 lights, the illumination light L3 in the third wavelength range (for example, red) emitted from the light emitting element LD3 illuminates the second area A2. That is, the light source LS2 is configured to emit the illumination light L1, the illumination light L2, and the illumination light L3 toward the second area A2.

The display device adopting this illumination device IL can achieve the same effects as in the configuration example. Compared with the configuration example shown in FIG. 6, the light guide LG1 and the light guide LG2 are omitted. Thus, the number of components is reduced and cost is lowered.

Next, the following will describe several configuration examples of pixel layouts in the display area DA. In each of the configuration examples to be described below, the figures show pixel electrodes among elements constituting the pixel. In contrast, the illustration of the other components such as the common electrode and the color filters is omitted.

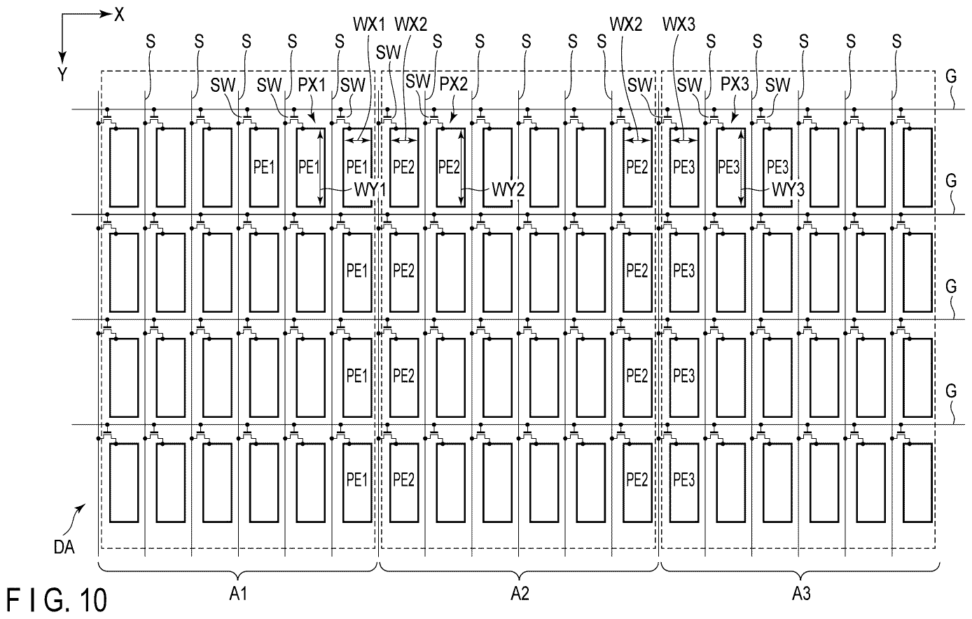

FIG. 10 is a view showing a configuration example of a pixel layout in the display area DA.

The plurality of scanning lines G are arranged in the second direction Y and each extend in the first direction X across the first area A1, the second area A2, and the third area A3. The pitch of the plurality of scanning lines G in the second direction Y is constant.

The plurality of signal lines S are arranged in the first direction X and each extend in the second direction Y. The pitch of the plurality of signal lines S in the first direction X is constant.

Each of the pixel PX1, the pixel PX2, and the pixel PX3 corresponds to an area partitioned by two adjacent scanning lines G in the second direction Y and two adjacent signal lines S in the first direction X. As described above, the pitch of the plurality of scanning lines G is constant and the pitch of the plurality of signal lines S is constant. Thus, the pixel PX1, the pixel PX2, and the pixel PX3 have the same size.

Each of the pixel electrode PE1 of the pixel PX1, the pixel electrode PE2 of the pixel PX2, and the pixel electrode PE3 of the pixel PX3 is electrically connected to the scanning line G and the signal line S via the switching element SW. The pixel electrode PE1, the pixel electrode PE2, and the pixel electrode PE3 have the same size. Thus, a width WX1 of the pixel electrode PE1 along the first direction X, a width WX2 of the pixel electrode PE2 along the first direction X, and a width WX3 of the pixel electrode PE3 along the first direction X are equivalent to each other. Further, a width WY1 of the pixel electrode PE1 along the second direction Y, a width WY2 of the pixel electrode PE2 along the second direction Y, and a width WY3 of the pixel electrode PE3 along the second direction Y are also equivalent to each other.

In this pixel layout, three pixels PX1 arranged in the first direction X display a color image in the first area A1, whereas one pixel PX2 displays a color image in the second area A2. Thus, the second area A2 achieves about triple definition in the first direction X compared with the first area A1.

Similarly, three pixels PX3 arranged in the first direction X display a color image in the third area A3. Thus, the second area A2 achieves about triple definition in the first direction X compared with the third area A3.

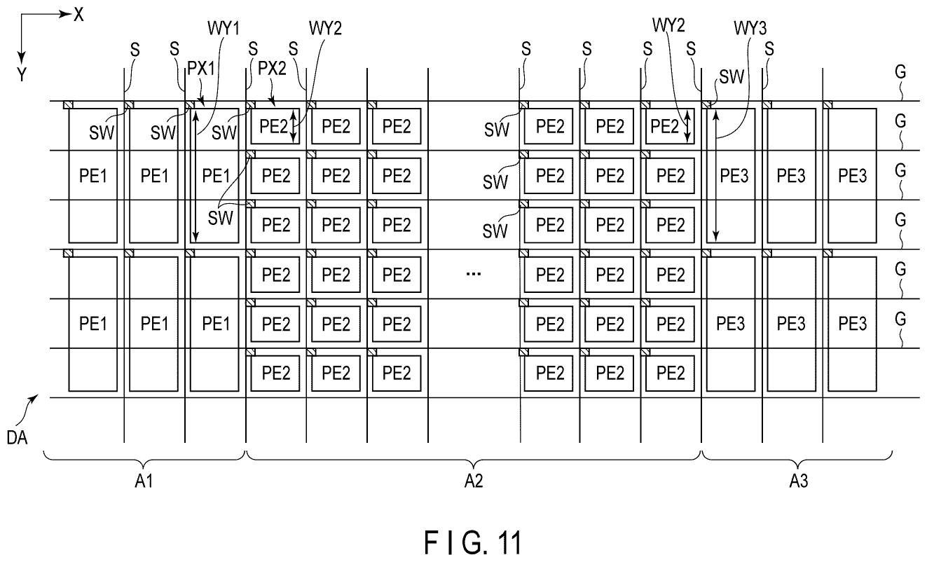

FIG. 11 is a view showing another configuration example of the pixel layout in the display area DA. FIG. 11 shows the switching element SW in a simplified manner.

The plurality of scanning lines G each extend in the first direction X and are arranged at a constant pitch in the second direction Y. The plurality of signal lines S each extend in the second direction Y and are arranged at a constant pitch in the first direction X.

The pixel PX2 corresponds to an area partitioned by two adjacent scanning lines G in the second direction Y and two adjacent signal lines S in the first direction X. Each of the pixel PX1 and the pixel PX3 corresponds to an area partitioned by the two outermost scanning lines among four scanning lines G arranged in the second direction Y and two adjacent signal lines S in the first direction X. Each of the pixel PX1 and the pixel PX3 has a size three times that of the pixel PX2.

The pixel electrode PE2 has a smaller size than each of the pixel electrode PE1 and the pixel electrode PE3. In the illustrated example, the pixel electrode PE1 has the same size as the pixel electrode PE3.

The width WY2 of the pixel electrode PE2 along the second direction Y is smaller than the width WY1 of the pixel electrode PE1 along the second direction Y and the width WY3 of the pixel electrode PE3 along the second direction Y (WY1>WY2) and (WY3>WY2). For example, the width WY2 is one-third or less of the width WY1. The width WY1 and the width WY3 are equivalent to each other (WY1=WY3).

In the same manner as the configuration example shown in FIG. 10, the width of the pixel electrode PE1 along the first direction X, the width of the pixel electrode PE2 along the first direction X, and the width of the pixel electrode PE3 along the first direction X are equivalent to each other.

In the illustrated example, the pixel electrode PE2 is provided between two scanning lines G adjacent in the second direction Y, and the pixel electrode PE1 crosses at least one of the two scanning lines G that sandwich the pixel electrode PE2. One pixel electrode PE1 and each of three pixel electrodes PE2 arranged in the second direction Y are aligned in the first direction X. The pixel electrode PE3 crosses at least one of the two scanning lines G that sandwich the pixel electrode PE2. One pixel electrode PE3 and each of three pixel electrodes PE2 arranged in the second direction Y are aligned in the first direction X.

As in the configuration shown in FIG. 10, in the configuration example adopting this pixel layout, the second area A2 achieves about triple definition in the first direction X compared with the first area A1 and the third area A3. Further, the second area A2 also achieves about triple definition in the second direction Y compared with the first area A1 and the third area A3.

The layout is not limited to the pixel layout where one pixel electrode PE1 and each of three pixel electrodes PE2 arranged in the second direction Y are aligned in the first direction X. Pixel layouts in which one pixel electrode PE1 and each of a plurality of pixel electrodes PE2 arranged in the second direction Y are aligned in the first direction X can improve definition in the second direction Y in the second area A2 compared with the first area A1.

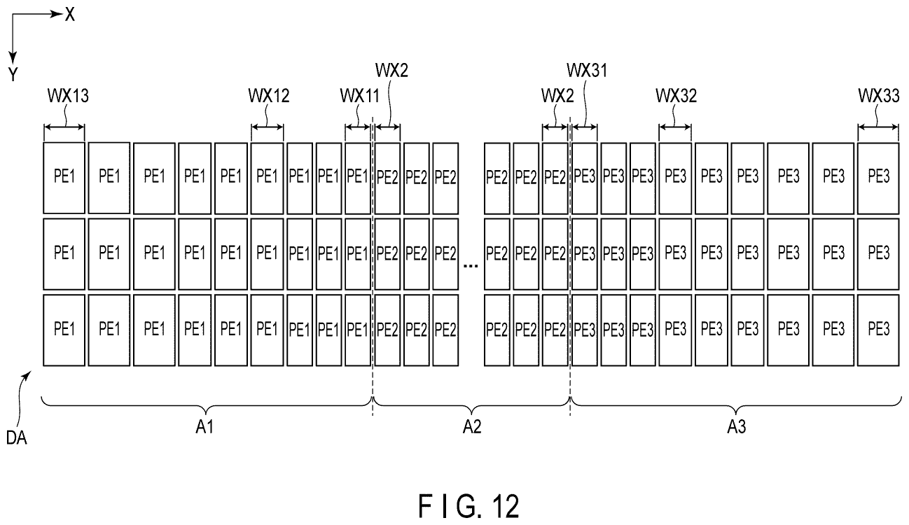

FIG. 12 is a view showing another configuration example of the pixel layout in the display area DA. FIG. 12 omits the illustration of the scanning lines, the signal lines, and the switching elements.

In the first area A1, the plurality of pixel electrodes PE1 arranged in the first direction X expand in the first direction X with increasing distance from the second area A2. That is, the pixel electrode PE1 adjacent to the second area A2 has a width WX11 along the first direction X. The pixel electrode PE1 that is farther from the second area A2 than the pixel electrode PE1 having the width WX11 has a width WX12 along the first direction X. The pixel electrode PE1 that is farthest from the second area A2 has a width WX13 along the first direction X. The width WX11 is smaller than the width WX12, and the width WX12 is smaller than the width WX13 (WX11<WX12<WX13).

In the third area A3, the plurality of pixel electrodes PE3 arranged in the first direction X expand in the first direction X with increasing distance from the second area A2. That is, the pixel electrode PE3 adjacent to the second area A2 has a width WX31 along the first direction X. The pixel electrode PE3 that is farther from the second area A2 than the pixel electrode PE3 having the width WX31 has a width WX32 along the first direction X. The pixel electrode PE3 that is farthest from the second area A2 has a width WX33 along the first direction X. The width WX31 is smaller than the width WX32, and the width WX32 is smaller than the width WX33 (WX31<WX32<WX33).

In the second area A2, all of the pixel electrodes PE2 have the same width WX2 along the first direction X. For example, the width WX2, the width WX11 and the width WX31 are equivalent to each other.

As in the same manner as the configuration example shown in FIG. 10, the widths of all of the pixel electrodes PE1 along the second direction Y, the widths of all of the pixel electrodes PE2 along the second direction Y, and the widths of all of the pixel electrodes PE3 along the second direction Y are equivalent to each other in the illustrated example.

As in the above configuration examples, in the configuration example adopting this pixel layout, the second area A2 achieves high definition in the first direction X compared with the first area A1 and the third area A3. Further, definition along the first direction X in each of the first area A1 and the third area A3 increases gradually with proximity to the second area A2 that is the high-definition area. Thus, visibility of definition differences between the second area A2 and the first area A1 and between the second area A2 and the third area A3 are reduced.

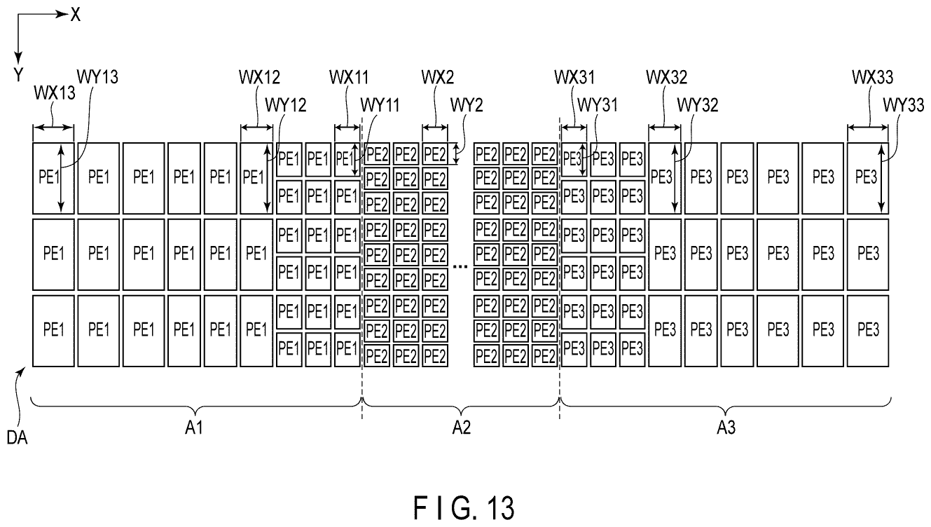

FIG. 13 is a view showing another configuration example of the pixel layout in the display area DA. FIG. 13 omits the illumination of the scanning lines, the signal lines, and the switching elements.

The configuration example shown in FIG. 13 differs from the configuration example shown in FIG. 12 in that definition along the second direction Y in each of the first area A1 and the third area A3 gradually increases with proximity to the second area A2.

In the first area A1, the plurality of pixel electrodes PE1 arranged in the first direction X expand in the second direction Y with increasing distance from the second area A2. That is, the pixel electrode PE1 adjacent to the second area A2 has the width WY11 along the second direction Y. The pixel electrode PE1 that is farther from the second area A2 than the pixel electrode PE1 having the width WY11 has the width WY12 along the second direction Y. The pixel electrode PE1 that is farthest from the second area A2 has the width WY13 along the second direction Y. The width WY11 is smaller than the width WY12 (WY11<WY12). In the illustrated example, the width WY12 and the width WY13 are equivalent to each other. Alternatively, the width WY12 may be smaller than the width WY13.

In the third area A3, the plurality of pixel electrodes PE3 arranged in the first direction X expand in the second direction Y with increasing distance from the second area A2. That is, the pixel electrode PE3 adjacent to the second area A2 has a width WY31 along the second direction Y. The pixel electrode PE3 that is farther from the second area A2 than the pixel electrode PE3 having the width WY31 has a width WY32 along the second direction Y. The pixel electrode PE3 that is farthest from the second area A2 has a width WY33 along the second direction Y. The width WY31 is smaller than the width WY32 (WY31<WY32). In the illustrated example, the width WY32 and the width WY33 are equivalent to each other. Alternatively, the width WY32 may be smaller than the width WY33.

In the second area A2, all of the pixel electrodes PE2 have the same width WY2 along the second direction Y. The width WY2 is smaller than the width WY11 and the width WY31.

The widths along the first direction X are the same as those in the configuration example shown in FIG. 12. That is, the width WX11 is smaller than the width WX12, and the width WX12 is smaller than the width WX13 (WX11<WX12<WX13). The width WX31 is smaller than the width WX32, and the width WX32 is smaller than the width WX33 (WX31<WX32<WX33).

As in the above configuration examples, in the configuration example adopting this pixel layout, the second area A2 achieves high definition in the first direction X and the second direction Y compared with the first area A1 and the third area A3. Further, definition along the second direction Y in each of the first area A1 and the third area A3 increases gradually with proximity to the second area A2 that is the high-definition area. Thus, visibility of definition differences between the second area A2 and the first area A1 and between the second area A2 and the third area A3 are reduced.

In the above embodiments, for example, the pixel PX1 in the first area A1 corresponds to the first pixel, the pixel PX2 in the second area A2 corresponds to the second pixel, and the pixel PX3 in the third area A3 corresponds to the third pixel.

The light source LS1 corresponds to the first light source, and the light source LS2 corresponds to the second light source.

The light emitting element LD1 corresponds to the first light emitting element, the light emitting element LD2 corresponds to the second light emitting element, the light emitting element LD3 corresponds to the third light emitting element, and the light emitting element LD0 corresponds to the fourth light emitting element.

The light guide LG1 corresponds to the first light guide, the prism portion P11 corresponds to the first prism portion, and the flat portion F1 corresponds to the first flat portion. The light guide LG2 corresponds to the second light guide, the prism portion P2 corresponds to the second prism portion, and the flat portion F11 corresponds to the second flat portion.

The sub-frame period SF1 corresponds to the first sub-frame period, the sub-frame period SF2 corresponds to the second sub-frame period, and the sub-frame period SF3 corresponds to the third sub-frame period.

Each of the pixel electrodes PE1 and PE11 to PE13 corresponds to the first pixel electrode. Each of the pixel electrodes PE2 and PE21 to PE26 corresponds to the second pixel electrode. Each of the pixel electrodes PE3 and PE31 to PE33 corresponds to the third pixel electrode.

The embodiments described above can provide a display device capable of improving the display quality.

While certain embodiments of the present disclosure have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is

1. A display device, comprising:
a liquid crystal panel comprising a first area having a plurality of first pixels and a second area having a plurality of second pixels in a display area for displaying images;
an illumination device configured to illuminate the liquid crystal panel; and
a controller configured to control the liquid crystal panel and the illumination device, wherein
each of the plurality of first pixels comprises a color filter,
each of the plurality of second pixels does not comprise a color filter,
the illumination device comprises:
a first light source configured to emit white illumination light toward the first area; and
a second light source comprising a first light emitting element configured to emit illumination light in a first wavelength range toward the second area and a second light emitting element configured to emit illumination light in a second wavelength range different from the first wavelength range toward the second area, and
the controller is configured to control the second area to display a first-color image in the first wavelength range in synchronization with lighting of the first light emitting element, and control the second area to display a second-color image in the second wavelength range in synchronization with lighting of the second light emitting element.

2. The display device of claim 1, wherein
the controller is configured to:
lighten the first light emitting element but not lighten the second light emitting element during a first sub-frame period within a one-frame period;
not lighten the first light emitting element but lighten the second light emitting element during a second sub-frame period following the first sub-frame period; and
lighten the first light source over the first sub-frame period and the second sub-frame period.

3. The display device of claim 2, wherein
the controller is configured to:
write first video signals into the plurality of first pixels and write first sub-video signals for displaying the first-color image into the plurality of second pixels during the first sub-frame period; and
write second video signals equivalent to the first video signals into the plurality of first pixels and write second sub-video signals for displaying the second color image into the plurality of second pixels during the second sub-frame period.

4. The display device of claim 1, wherein
the illumination device further comprises:
a first light guide; and
a second light guide overlapping the first light guide,
the first light source faces a side surface of the first light guide,
the second light source faces a side surface of the second light guide, and
each of the first light guide and the second light guide overlaps the first area and the second area.

5. The display device of claim 4, wherein
the first light guide has:
a first prism portion including a plurality of prisms overlapping the first area; and
a first flat portion overlapping the second area, and
the second light guide has:
a second prism portion including a plurality of prisms overlapping the second area; and
a second flat portion overlapping the first area.

6. The display device of claim 5, wherein
the first area and the second area are arranged in a first direction, and
a width of the second prism portion along the first direction is greater than a width of the second area along the first direction.

7. The display device of claim 1, wherein
the illumination device further comprises a light guide,
the first light source is provided directly below the first area,
the second light source faces a side surface of the light guide, and
the light guide overlaps the first area and the second area.

8. The display device of claim 7, wherein
the light guide has:
a prism portion including a plurality of prisms overlapping the second area; and
a flat portion overlapping the first area.

9. The display device of claim 8, wherein
the first area and the second area are arranged in a first direction, and
a width of the prism portion along the first direction is greater than a width of the second area along the first direction.

10. The display device of claim 8, wherein
the first light source overlaps the flat portion.

11. The display device of claim 1, wherein
the first light source is provided directly below the first area, and
the second light source is provided directly below the second area.

12. The display device of claim 1, wherein
the liquid crystal panel comprises:
a first pixel electrode provided in each of the plurality of first pixels and overlapping the color filter;
a second pixel electrode provided in each of the plurality of second pixels;
a transparent resin layer overlapping the second pixel electrode;
a transparent overcoat layer covering the color filter and the transparent resin layer; and
a common electrode overlapping the first pixel electrode and the second pixel electrode.

13. The display device of claim 12, wherein
the liquid crystal panel further comprises a black matrix provided between the first pixels adjacent to each other, and
the black matrix is not provided between the second pixels adjacent to each other.

14. The display device of claim 12, wherein
the first area and the second area are arranged in a first direction, and
a width of the first pixel electrode along the first direction and a width of the second pixel electrode along the first direction are equivalent to each other.

15. The display device of claim 12, wherein
the first area and the second area are arranged in a first direction, and
a width of the second pixel electrode along a second direction intersecting the first direction is smaller than a width of the first pixel electrode along the second direction.

16. The display device of claim 15, wherein
the liquid crystal panel further comprises a plurality of scanning lines each extending in the first direction and arranged in the second direction,
the second pixel electrode is located between two scanning lines adjacent to each other in the second direction of the plurality of scanning lines, and
the first pixel electrode crosses at least one of the two scanning lines.

17. The display device of claim 15, wherein
one of the first pixel electrodes and each of the plurality of second pixel electrodes arranged in the second direction are aligned in the first direction.

18. The display device of claim 12, wherein
the first area and the second area are arranged in a first direction, and
among the plurality of first pixel electrodes provided respectively in the plurality of first pixels, a width along the first direction of the first pixel electrode adjacent to the second area is smaller than a width along the first direction of the first pixel electrode spaced from the second area.

19. The display device of claim 12, wherein
the first area and the second area are arranged in a first direction, and
among the plurality of first pixel electrodes provided respectively in the plurality of first pixels, a width along a second direction intersecting the first direction of the first pixel electrode adjacent to the second area is smaller than a width along the second direction of the first pixel electrode spaced from the second area.

20. The display device of claim 1, wherein
the liquid crystal panel further comprises a third area comprising a plurality of third pixels;
each of the plurality of third pixels comprises a color filter,
the first light source is configured to emit white illumination light toward the third area,
the first area, the second area, and the third area are arranged in this order along the first direction, and
a width of the first area along the first direction differs from a width of the third area along the first direction.
